(19) United States
(12) Patent Application Publication
(10) Pub. No.: US 2018/0169718 A1
(43) Pub. Date: Jun. 21, 2018

(54) METHODS FOR CLEANING GAS PIPELINES

(71) Applicant: Naveed Aslam, Houston, TX (US)

(72) Inventor: Naveed Aslam, Houston, TX (US)

(21) Appl. No.: 15/383,067

(22) Filed: Dec. 19, 2016

(51) Int. Cl. B08B 9/032

(52) U.S. Cl. CPC B08B 9/032

(57) ABSTRACT

A method is disclosed for cleaning a pipeline. A first gas or gas pig is fed into the pipeline as a cleaning gas. A second gas is then fed into the pipeline and acts as a motive gas to drive the first gas or gas pig through the pipeline. The first gas may contain additives such as micro carriers that are a core material surrounded by an outer shell that may contain corrosion inhibitors to treat localized corrosion in the pipeline.

### BACKGROUND OF THE INVENTION

Hydrocarbons are frequently transported via pipeline systems which can be situated in a number of locations such as underground, undersea or above ground. These pipelines will become dirty through this contact with the hydrocarbons and contaminants therein. Gases are typically used to clean these impurities in pipelines and related process equipment as their pressure force transfers its momentum to trapped solid or liquid particles, and removes these deposits through mechanical force.

Typically an inert gas such as nitrogen or argon is used for this purpose. However, these gases tend to have limited utility as most solid and liquid contaminants and impurities are not readily soluble in inert gases. Combine this with limitations of momentum transfer from gas to impurity and their removal mechanisms can be somewhat limited.

Alternatively pigs are employed to clean the pipelines. These pigs are based on high density solid materials and are inserted into the pipeline where the flow of the hydrocarbons pushes it down the pipe. The pig will contact the sides of the pipeline and clean off impurities, all without stopping the flow of the hydrocarbons in the pipeline.

However, pigs also have certain drawbacks due to their size and weight and particularly with respect to variations in pipeline conditions.

For example, 42% of natural gas lines and 11% of liquid lines in the United States cannot accommodate traditional pigs due to physical limitations. The piggability of a specific pipeline is not a very well defined metric and could vary from service to region.

Typical key factors in defining piggability are length of the pipeline. The distance between two pig traps is variable and can cause a wear and tear and loss of functionality of pigs as evidenced by natural gas pipelines having 50 to 100 miles between traps. This is further an issue where refined products are 100 to 150 miles between traps and crude oil pipelines are 150 to 200 miles between traps. Additionally, dual diameter pipelines and reducers are variable. Linings are used in pipelines to protect the inside of the pipe from the effects of the products travelling therein and to create less resistance. Pigs can damage these linings which can lead to pipeline failure. Bends need to be forged, particularly when the radius of the pipeline is small and solid pigs can get stuck at these bends. Further field bends can cause local deformations exceeding 2 to 3% of the pipeline diameter which can cause problems for the pig travelling through the pipeline.

Additionally miter bends, wall thickness variations, tees, off-takes, barred tees, valves and check valves, pipe elevations and spans and non-engineered spans, drips, siphons and pipeline carrots and coupon holders all introduce variables in the pipeline that make traditional pigging operations problematic.

Cleaning and monitoring of oil and gas pipelines after service or after routine shutdown or for new service is an essential component of safe and successful operation and delivery of energy products. The routine cleaning of pipelines is essential for consistent product specification and full capacity operations. Cleaning and monitoring these large systems requires large scale effort such as water washing for cleaning and decontamination or extensive pigging. For long distance gas pipelines, the cleaning is done through pigging. Pigging though effective is not always a trouble free operation and may not lead to a complete cleaning. Further, the mechanical action of pigs can lead to the possible loss of coatings and pipeline materials.

The present invention addresses these issues as it utilizes a method whereby two gases are used to clean a pipeline. A first gas is used to provide the motive force through the pipeline and the second gas acts as the cleaning medium for the pipeline.

### SUMMARY OF THE INVENTION

In one embodiment of the invention, there is disclosed a method for cleaning a pipeline comprising the steps of introducing a first gas into the pipeline and introducing a second gas into the pipeline.

In a second embodiment of the invention, there is disclosed a method for pigging a pipeline comprising introducing a gas pig into the pipeline and then introducing a second gas.

In a third embodiment of the invention, there is disclosed a micro carrier composition comprising a microcapsule comprising an outside polymeric shell surrounding an internal impregnated gel.

In the methods of the invention, the first gas or cleaning gas is added to the pipeline to be cleaned. After a period of time introducing this first gas, a second gas is then added to the pipeline. This second gas is different from the first gas and with the assistance of an appropriate injector and pump will provide the motive force to push the first, cleaning gas through the pipeline.

The cleaning gas is typically nitrogen or supercritical carbon dioxide. The density of the cleaning gas can be the same as the motive gas but can also have different functionality, such as containing departiculation systems and impurity dissolution systems. Preferably, the cleaning gas should be heavier and slower than the motive gas.

The motive or motive force gas can be any gas that could be injected into a pipeline. Preferably, the motive force gas should be lighter and faster than the cleaning gas.

Both the cleaning gas and the motive gas can be mixtures of gases. In actual practice there may be some inter diffusion of the cleaning gas and the motive gas. However, this can be controlled by the operator through setting of different velocities for the cleaning gas and the motive gas. A mixture of gases for either the cleaning gas and/or motive gas would face the same potential challenges of diffusion but could be managed by the operator through the use of setting the proper velocities for the gases.

The gases whether the cleaning gas or motive gas will typically be injected into the pipeline to be treated by an injector and what could be a specially designed nozzle. This introduction point can be along with the flow of the product in the pipeline or upstream of this flow along the length of pipeline to be treated.

The gases can be fed in ranges from 200 psig to 1400 psig and at temperatures of 15° to 35° C. The gases are moving through the pipeline at speed in the range of from 30 to 70 feet per second (fps).

The relative ratios of the time that the motive gas and the cleaning gas are in the pipeline are roughly 10 to 20 percent for the cleaning gas and 80 to 90 percent for the motive gas. So for a 100 minute clean, the motive gas would be present from 80 to 90 minutes passing through the pipeline and the cleaning gas would be present from 10 to 20 minutes.

The gases would be injected into the pipeline so that both the cleaning gas and motive gas would traverse the length of the pipeline, or as far as the operator deemed necessary.

The cleaning gas may also contain additives that assist in cleaning the pipeline or providing other treatments therein. For example, smart micro-particles that contain corrosion inhibitors can be inserted into the cleaning gas. These particles would have molecular sensors mounted in their outer shell which would enable them to detect local corrosion of the pipeline through electro-chemical coupling. Once the signal is produced and received, the smart micro-particles can release their corrosion inhibitor locally.

The smart micro-particles of the present invention when employed for corrosion inhibition can be configured as microcapsules. The microcapsule will comprise an outside polymeric shell with the inside being an inhibitor reservoir in the form of an impregnated gel.

The surface of the outside polymeric shell will be designed to sense the local corrosion within a pipeline. When local corrosion is sensed, a mechanism induces the release of the stored corrosion inhibitors from the internal gel stores. The inhibitor release mechanism is induced either through the mechanical degradation of outer shell polymer by the local corrosion products or by sensitivity to local changes in pH in the pipeline. As such, the microcapsules provide both sensing of localized corrosion as well as the mechanism to provide protection to that localized corrosion.

These vessels may further be comprised of intrinsically conductive polymers (ICPs) selected from the sulfonic and phosphonic salts of polyaniline (PANi). Some examples of these polymers include PANi-p-toluene sulfonic acid, PANi dinonylnaphthalene disulfonic acid and PANi aminotri(methylene phosphonic acid) and PANi-methylphosphonic acid.

Although not wanting to be held to any one theory of operation, the present inventor believes that ICPs shift the reaction site of oxygen reduction from the metallopolymers interface into the polymer, which thereby reduces the concentration of free radical hydroxyl at the interface thus reducing the rate of cathode reaction.

Alternatively, it is believed that under corrosion conditions, the ICP could be reduced and releases its dopants because of galvanic potential difference between the metal of the pipeline and the ICPs. As such, the PANI salts could release the dopant anions and protons.

pH-sensitive microcapsules for corrosion sensing and protection could provide a controlled release system that combines the advantages of corrosion sensing and protection using a pH triggered release of inhibitor. The contents of the inhibitors thereby could be completely released in a relatively short time such as two or three hours if the pH is around 8 to 10 or 1 to 4. These pH ranges are usually observed when localized corrosion is encountered.

These microcapsules therefore will be carried in a sweep inert gas such as nitrogen through the pipeline and when the microcapsules interact with the localized corrosion sites, they will release their contents. The pH sensitivity and controlled release function of these microcapsules is based on the hydrolysis reaction of the degradable polymer. Accordingly, there could be four possible bond types which are hydrolysis-susceptible bonds which are represented by anhydrides, esters, carbonates, and amides. Polyesters are relatively stable when there is no catalyst but can undergo rapid hydrolysis reaction under both acidic or basic conditions. The microcapsule will break down due to the ester hydrolysis reaction thereby making the microcapsule pH sensitive.

The pipelines that can be treated by the methods of the present invention include oil and gas pipelines. They could also be employed in main transmission as well as gathering lines.

The contaminants that are frequently encountered and which can be treated by the methods of the present invention include corrosion products, heavy solids such as asphaltene types of depositions, sand, dirt, salts and hydrocarbon gases.

The methods of the present invention can be employed in pipelines that are operating live as in carrying actual product to a destination. The methods could also be employed during commissioning of a pipeline, or during turn around operations.

A further advantage that the methods of the present invention have over solid pigging operations is that the gas can easily be vented at the end of the cleaning operations. There is no need then for pigs to be launched, retrieved and relaunched and the inherent cost realized therein.

Likewise the contaminants are dissolved in the cleaning as and are vented with the gas. Depending upon the nature of the contaminants, the gas can be flared in an environmentally acceptable manner.

### BRIEF DESCRIPTION OF THE DRAWINGS

FIG. 1 is a schematic of a gas pipeline that is being cleaned according to the methods of the invention.

FIG. 2 is a schematic of a gas pipeline showing the interaction of cleaning gas, pipeline contaminants and the motive gas.

FIG. 3 is a schematic representing gas molecules progressing through a pipeline.

FIG. 4 is a schematic showing gas molecules and nano or micro carriers progressing through a pipeline.

FIG. 5 is a schematic representing two separate gas pigs progressing through a pipeline.

FIG. 6 is a schematic representing micro smart carriers containing corrosion inhibitors in a pipeline experiencing corrosion.

### DETAILED DESCRIPTION OF THE INVENTION

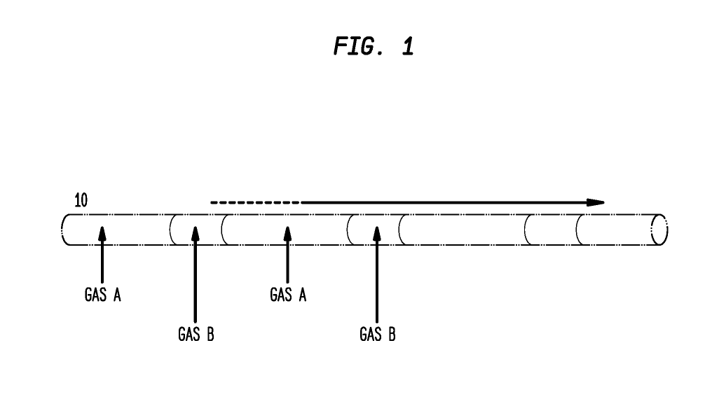

FIG. 1 describes the cleaning method according to the present invention. A gas pipeline 10 in need of cleaning has a first gas introduced, gas B which will act to clean the pipeline 10 of deposits, build ups, impurities and other chemical and biological contaminants. This first gas is introduced for a set period of time before a second gas is introduced. This second gas, Gas A will provide the motive force to Gas B and will push the Gas B through the pipeline 10.

In FIG. 1 it is shown that the gases that comprises Gas A and Gas B can be introduced in an alternative fashion such that the cleaning Gas B is injected into the pipeline 10, then the motive Gas A is injected into the pipeline 10. As Gas B becomes more contaminated with the products of the cleaning, new shots or injections of Gas B will be necessary to ensure that the appropriate cleaning occurs. This alternating approach can be performed as necessary to ensure that fresh injections of Gas B are introduced into the pipeline 10.

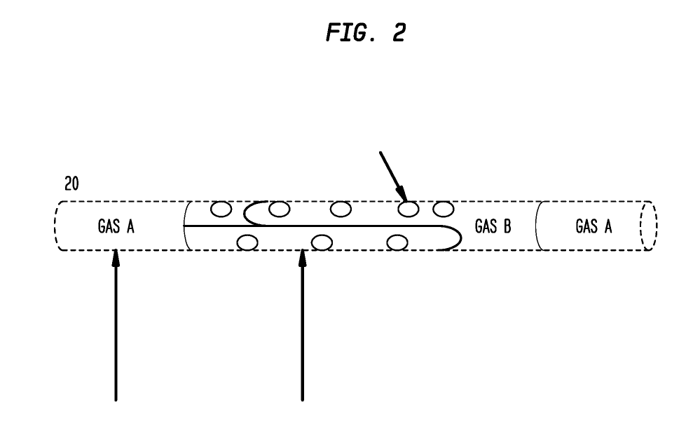

FIG. 2 shows a pipeline 20 with contaminants on the interior walls of the pipeline 20. The cleaning gas, Gas B will be introduced and will interact with these pipeline contaminants thereby removing them from the walls of the gas pipeline 20.

Gas B will pass through the pipeline 20 and contact the contaminants on the interior walls of the pipeline 20. This Gas B will soon become contaminated with the contaminants that it so removes and must be, not only pushed through the pipeline 20 but be supplemented by fresh cleaning Gas B. To that end, the operator will inject Gas B into the pipeline 20 to be cleaned for a determinant period of time. Once this time is passed, Gas A is injected into the pipeline 20 for a determinant period of time. Gas A will drive the Gas B through the pipeline 20 and also assist in pushing the so removed contaminants through the pipeline 20. After the set period for introducing Gas A into the pipeline 20 has expired, fresh Gas B will be introduced and this alternating pattern can occur for as long as the pipeline 20 to be judged clean.

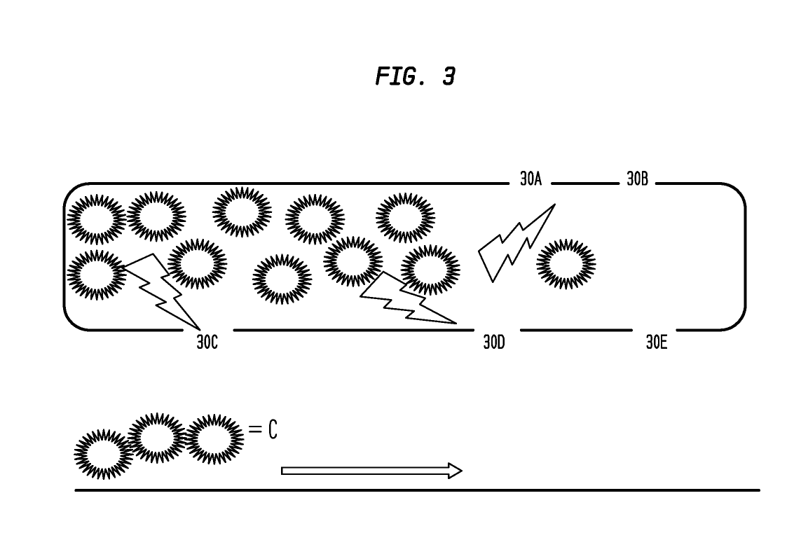

FIG. 3 represents a schematic of a pipeline that can be treated by the methods of the present invention. The departiculation system represented in pipeline 30 shows particles C such as fine hard nano particles like silica nano particles as well as localized corrosion areas identified as 30A, 30B, 30C, 30D and 30E. These particles once they contact impurities or contaminants in the pipeline will transfer momentum from high velocity moving gas phase to the stationary solid phase or liquid phase which reduces their size. These impurities or contaminants once reduced in size become dissolvable in reverse micro emulsion particles, and will exit the pipeline when the gases are thereby removed.

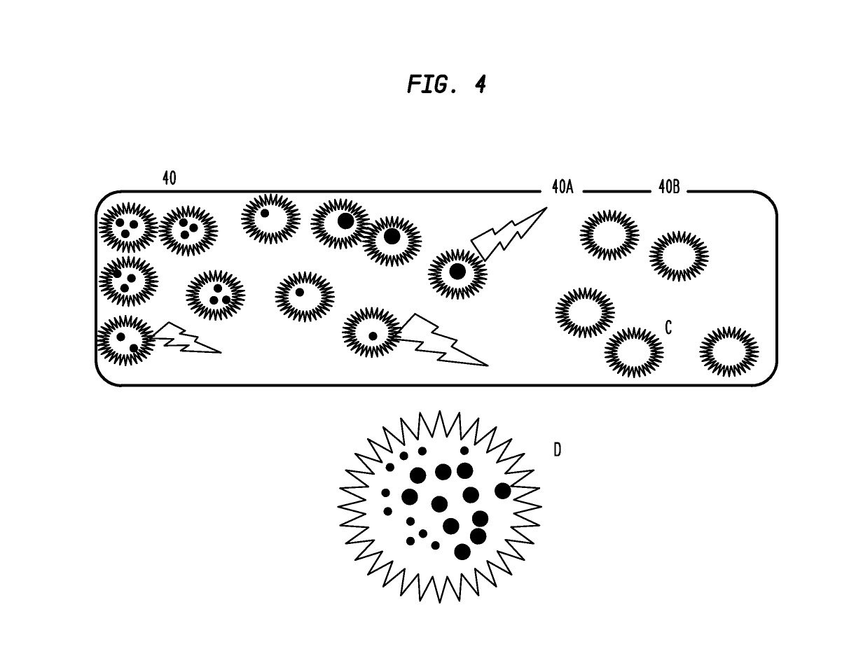

In FIG. 4, nano or micro carriers are shown as D along with particles C from FIG. 3. The pipeline 40 shows the nano or micro carriers D along with the nano particles C. The nano or micro carriers D will contain fine nano particles which can be release to departiculate impurities encountered on the pipeline 40 walls 40A and 40B. These are particularly useful additives to employ when gas sweeps of long distances of 100 miles are performed. These particles will ensure that departiculation nano particles are being delivered to the pipeline 40 along the length of the projected cleaning operation.

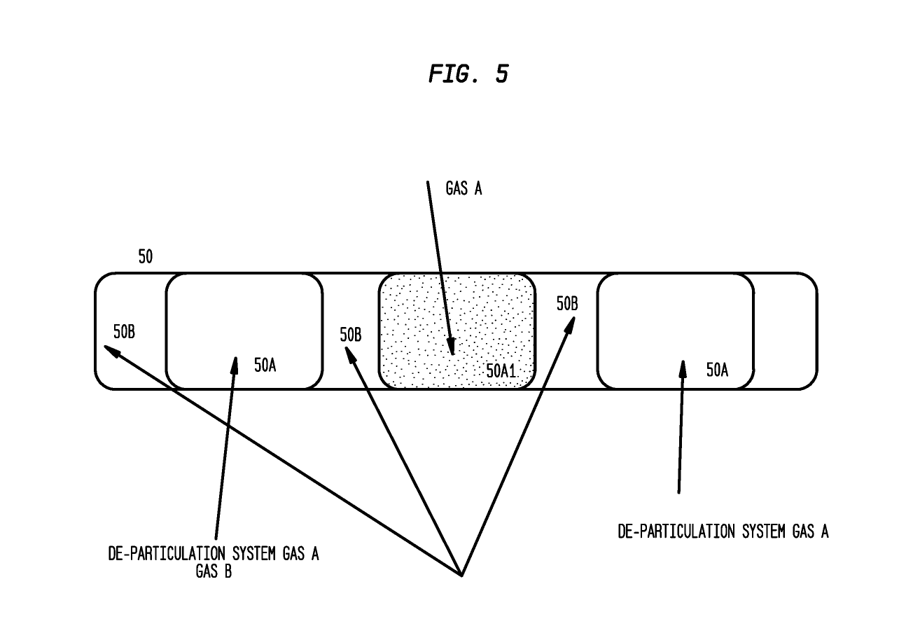

FIG. 5 is a schematic representation of the two gases, motive and cleaning, being present in a length of pipeline 50. Gas B is the cleaning gas such as supercritical carbon dioxide and is represented as a segment 50B followed by a departiculation system or gas A which is the motive gas represented twice as 50A. The center section of this schematic is also gas A or the motive gas 50A1 and shows the dissolution of impurities and their removal by the motive gas sweeping along the length of the pipeline 50 to be cleaned. As discussed, these dissolved impurities will be carried out of the system by the gases.

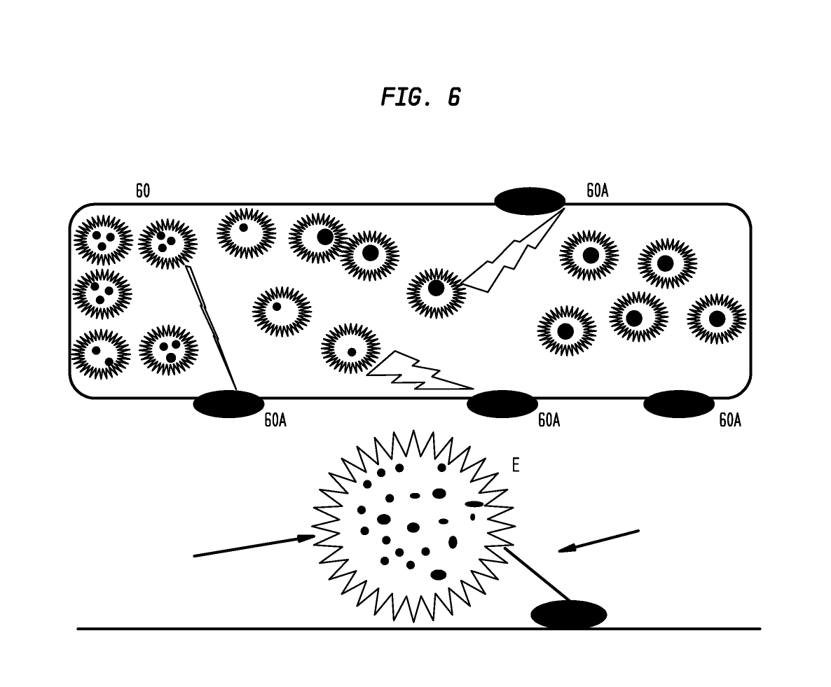

In FIG. 6, a pipeline 60 is shown bearing local corrosion deposits 60A. Micro corrosion inhibitor carriers E are represented as being present in the cleaning gas that is passing through the pipeline 60.

The micro corrosion inhibitor carriers E are micro particles 2 to 10 micrometers in diameter having an outer polymer shell. The outer polymer shell will contain sensors that are activated through electrochemical coupling with local corrosion events inside a pipeline. The polymer is an electroactive polymer that is sensitive to local electrochemical activity. Once the electropolymer is activated, it provides an activation signal to a gel like structure that is impregnated with inhibitor within the outer polymer shell. The inhibitor is then released and will be release only when within the range of electrochemical coupling with the local corrosion event.

This localized activation is more efficient with increased cost savings as previous corrosion inhibition methods would simply add the inhibitor to the length of the pipeline that is to be treated. Much of the inhibitor thereby went to waste. According to the methods of the present invention, only that amount of corrosion inhibitor that is needed as encountered will be deployed. Accordingly, these smart particles can be included with the motive gas in the methods of the present invention to treat localized corrosion deposits.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for cleaning a pipeline comprising the steps of feeding a first gas into the pipeline and then feeding a second gas into the pipeline.

2. The method as claimed in claim 1 wherein the first gas is a cleaning gas.

3. The method as claimed in claim 2 wherein the cleaning gas is selected from the group consisting of nitrogen and supercritical carbon dioxide.

4. The method as claimed in claim 1 wherein the second gas is a motive gas.

5. The method as claimed in claim 4 wherein the motive gas is lighter than the cleaning gas.

6. The method as claimed in claim 1 wherein the first gas is a mixture of gases.

7. The method as claimed in claim 1 wherein the second gas is a mixture of gases.

8. The method as claimed in claim 1 wherein the first gas and the second gas are injected into the pipeline by an injector.

9. The method as claimed in claim 8 wherein the injector is located along the length of the pipeline.

10. The method as claimed in claim 8 wherein the first gas and the second gas are injected at pressures ranging from 200 psig to 1400 psig.

11. The method as claimed in claim 8 wherein the first gas and the second gas are injected at temperatures of 15° to 35° C.

12. The method as claimed in claim 1 wherein the first gas and the second gas are traveling through the pipeline at 30 to 70 feet per second.

13. The method as claimed in claim 1 wherein the first gas is present from 80 to 90 percent and the second gas is present at 10 to 20 percent of the time that the first gas and the second gas are present in the pipeline.

14. The method as claimed in claim 1 further comprising introducing additives into the first gas or the second gas.

15. The method as claimed in claims 14 wherein the additives are selected from the group consisting of nano particles, nano carriers, micro-particles, micro carriers, micro corrosion inhibitor carriers.

16. The method as claimed in claim 15 wherein the micro-particles are microcapsules.

17. The method as claimed in claim 16 wherein the microcapsules comprise an outside polymeric shell surrounding an internal impregnated gel.

18. The method as claimed in claim 17 wherein the impregnated gel contains a corrosion inhibitor.

19. The method as claimed in claim 17 wherein the outside polymeric shell comprises an intrinsically conductive polymer selected from the group consisting of sulfonic and phosphonic salts of polyaniline.

20. A method for pigging a pipeline comprising feeding a gas pig into the pipeline and then feeding a second gas into the pipeline.

21. The method as claimed in claim 20 wherein the gas pig is a cleaning gas.

22. The method as claimed in claim 21 wherein the cleaning gas is selected from the group consisting of nitrogen and supercritical carbon dioxide.

23. The method as claimed in claim 20 wherein the second gas is a motive gas.

24. The method as claimed in claim 23 wherein the motive gas is lighter than the cleaning gas.

25. The method as claimed in claim 20 wherein the gas pig is a mixture of gases.

26. The method as claimed in claim 20 wherein the second gas is a mixture of gases.

27. The method as claimed in claim 20 wherein the gas pig and the second gas are injected into the pipeline by an injector.

28. The method as claimed in claim 27 wherein the injector is located along the length of the pipeline.

29. The method as claimed in claim 27 wherein the gas pig and the second gas are injected at pressures ranging from 200 psig to 1400 psig.

30. The method as claimed in claim 27 wherein the gas pig and the second gas are injected at temperatures of 15° to 35° C.

31. The method as claimed in claim 20 wherein the gas pig and the second gas are traveling through the pipeline at 30 to 70 feet per second.

32. The method as claimed in claim 20 wherein the gas pig is present from 80 to 90 percent and the second gas is present at 10 to 20 percent of the time that the gas pig and the second gas are present in the pipeline.

33. The method as claimed in claim 20 further comprising introducing additives into the gas pig or the second gas.

34. The method as claimed in claims 33 wherein the additives are selected from the group consisting of nano particles, nano carriers, micro-particles, micro carriers, micro corrosion inhibitor carriers.

35. The method as claimed in claim 34 wherein the micro-particles are microcapsules.

36. The method as claimed in claim 35 wherein the microcapsules comprise an outside polymeric shell surrounding an internal impregnated gel.

37. The method as claimed in claim 36 wherein the impregnated gel contains a corrosion inhibitor.

38. The method as claimed in claim 36 wherein the outside polymeric shell comprises an intrinsically conductive polymer selected from the group consisting of sulfonic and phosphonic salts of polyaniline.

39. A micro carrier composition comprising a microcapsule comprising an outside polymeric shell surrounding an internal impregnated gel.

40. The composition as claimed in claim 39 wherein the impregnated gel contains a corrosion inhibitor.

41. The composition as claimed in claim 39 wherein the outside polymeric shell comprises an intrinsically conductive polymer selected from the group consisting of sulfonic and phosphonic salts of polyaniline.

42. The composition as claimed in claim 39 wherein the microcapsule comprises an intrinsically conductive polymer selected from the group consisting of sulfonic and phosphonic salts of polyaniline.

43. The composition as claimed in claim 39 wherein the sulfonic and phosphonic salts of polyaniline are selected from the group consisting of PANi-p-toluene sulfonic acid, PANi dinonylnaphthalene disulfonic acid and PANi aminotri(methylene phosphonic acid) and PANi-methylphosphonic acid.

44. The composition as claimed in claim 39 wherein the outside polymeric shell is 2 to 10 micrometers in diameter.

45. The composition as claimed in claim 39 wherein the outside polymeric shell further comprises sensors.
